(19) United States
(12) Patent Application Publication
(10) Pub. No.: US 2024/0134254 A1
(43) Pub. Date: Apr. 25, 2024

(54) SPATIAL LIGHT MODULATOR WITH ARTIFACT REDUCTION

(71) Applicant: TEXAS INSTRUMENTS INCORPORATED, Dallas, TX (US)

(72) Inventors: WILLIAM C. MCDONALD, ALLEN, TX (US); BRADLEY HASKETT, MAGNOLIA, TX (US); MICHAEL DAVIS, RICHARDSON, TX (US)

(21) Appl. No.: 18/297,289

(22) Filed: Apr. 6, 2023

Related U.S. Application Data
(60) Provisional application No. 63/380,860, filed on Oct. 25, 2022.

(51) Int. Cl. G03B 21/00; G02B 1/11; G02B 26/08

(52) U.S. Cl. CPC G03B 21/008; G02B 1/11; G02B 26/0833

(57) ABSTRACT

A device includes a spatial light modulator (SLM) and a light shield. The SLM has first and second opposing sides and third and fourth opposing sides. The SLM includes an array of pixel elements. The SLM also includes reflective elements along the first side. At least some of the reflective elements have a metal layer. The light shield has a first portion adjacent the reflective elements. A gap between the metal layers and the light shield has a zig-zag shape.

### CROSS-REFERENCE TO RELATED APPLICATIONS

This application claims priority to U.S. Provisional Application No. 63/380,860, filed Oct. 25, 2022, which is hereby incorporated herein by reference in its entirety.

### BACKGROUND

A digital micromirror device (DMD) includes an array of micromirrors that can be individually controlled between on and off states. DMDs can be used, for example, as part of a projection system. A light source (e.g., a light enduing diode (LED) or a laser) emits light that reflects off the array. In the on state of a given mirror, reflected light from the mirror passes into an optical element and then onto, for example, a projection screen. In the off state, reflected light from the mirror does not pass into the optical element and onto the projection screen, and instead may pass to a heat sink. For at least some types of DMDs, light from reflective surfaces around the periphery of the array may undesirably reflect and scatter light into the optical element of the projection system, thereby manifesting as light artifacts in the resulting displayed image.

### SUMMARY

In at least one example, a device includes a spatial light modulator (SLM) and a light shield. The SLM has first and second opposing sides and third and fourth opposing sides. The SLM includes an array of pixel elements. The SLM also includes reflective elements along the first side. At least some of the reflective elements have a metal layer. The light shield has a first portion adjacent to the reflective elements. A gap between the metal layers and the light shield has a zig-zag shape.

### BRIEF DESCRIPTION OF THE DRAWINGS

FIG. 1 is an example of a light projection system that includes a DMD.

FIG. 2 is a top-down view of an example spatial light modulator.

FIG. 3 is a top-down view of an example digital micromirror device (DMD) having one or more zig-zag shaped gaps between angled extensions of some reflective elements and a light shield to reduce the occurrence of light artifacts.

FIGS. 4, 5, and 6 are views of an example reflective element included in the DMD that include angled extensions.

FIG. 7 is a view of an example reflective element of the DMD that does not include an angled extension.

FIG. 8 is a view of an example mirror of the DMD.

FIGS. 9-11 and 13-16 are side cross-sectional views of the DMD illustrating process steps to manufacture the DMD.

FIG. 12 is a top-down view of a mask used during the manufacture of the DMD.

FIGS. 17 and 18 are top-down views of an example DMD illustrating different angles associated with the angled extensions.

FIG. 19 is a top-down view of an example DMD illustrating angled extensions that span multiple reflective elements.

FIGS. 20 and 21 are top-down views of example DMDs illustrating alternative examples of the zig-zag shape between the angled extensions and the light shield.

### DETAILED DESCRIPTION

The same reference numbers or other reference designators are used in the drawings to designate the same or similar (either by function and/or structure) features.

The examples described herein pertain to a spatial light modulator (SLM) which reduces the occurrence of light artifacts which may result from light reflecting off surfaces around at least some of the periphery of an array of pixel elements. An example of a SLM as an array of mirrors of a DMD (e.g., micromirror structures) is presented, but the principles may apply to other types of SLMs (e.g., liquid crystal display elements, liquid crystal on silicon elements, etc.).

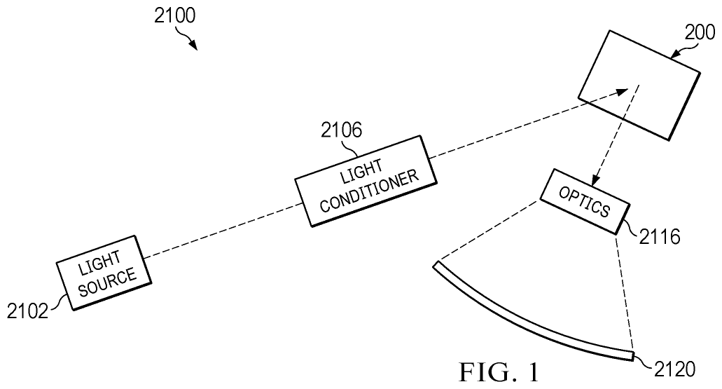

FIG. 1 is an example light projection system 2100, which includes a light source 2102 (e.g., LED, laser, etc.), a light conditioner 2106, optics 2116, DMD 200, and a projection surface 2120. The light conditioner 2106 may include a conditioner lens, optical integrator and optical elements. Optics 2116 may include one more optical lenses. Light from the light source 2102 is conditioned by light conditioner 2106. Light from the light conditioner 2106 reflects off the DMD 200 to produce modulated light. The modulated light reflected off DMD 200 passes through optics 2116 and onto projection surface 2120.

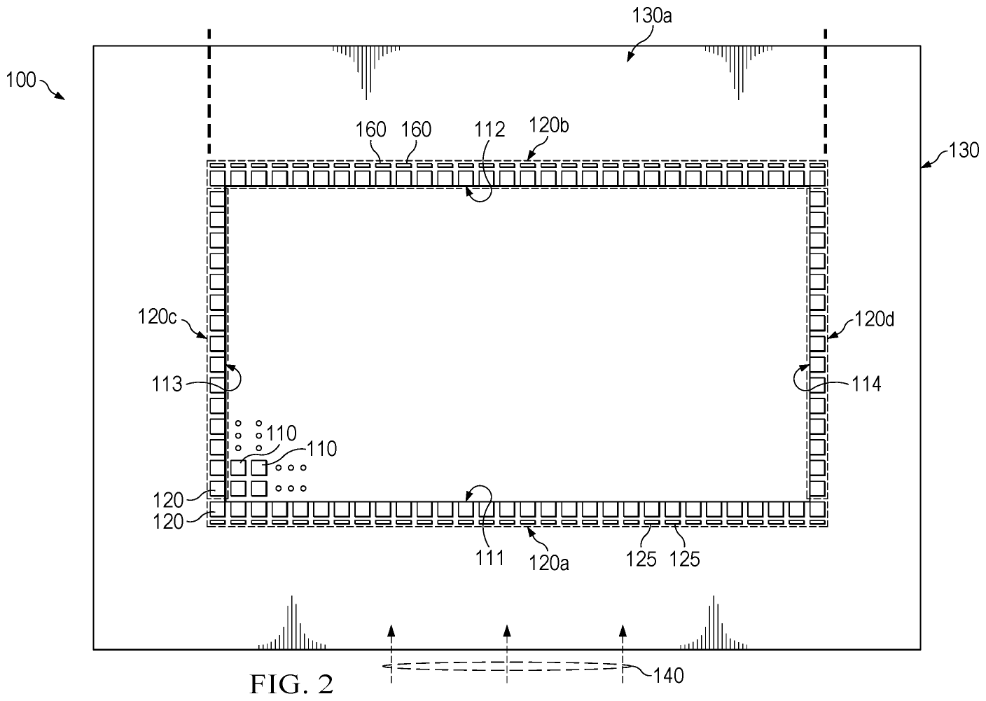

FIG. 2 is an example of an SLM 100 which includes an array of pixels 110, reflective elements 120a, 120b, 120c, and 120d (collectively, reflective elements 120), and a light shield 130. In one example, the SLM 100 is a DMD and the pixels 110 are pixel mirrors and are referred to as DMD 100 and pixel 110. The array of pixels 110 includes a frontside 111 which faces the incoming light 140, a backside 112 (opposite the frontside 111), and sides 113 and 114 orthogonal to the frontside 111 and backside 112. The sides 113 and 114 are between the frontside 111 and the backside 112.

In this example, incoming light 140 from a light source reflects off the array of pixels 110 from the bottom side of the DMD 100 and at an angle (e.g., 34 degrees) with respect to the plane of the DMD 100. The pixels 110 can be controlled to be in an on state or an off state. In the on state of a pixel mirror, light reflecting off the mirror passes through an optical element (not shown). In the off state of the mirror, light reflecting off the mirror does not pass through the optical element, and instead may pass towards a heat sink.

The reflective elements 120 also includes a mirror and can be controlled to be in the off state but not in the on state. In other words, each reflective element 120 cannot be controlled to cause light to reflect off the reflective elements 120 and into the optical element. The array of pixels 110 may be surrounded by the reflective elements 120. A row of reflective elements 120a is along the frontside 111 of the array of pixels 110. A row of reflective elements 120b is along the backside 112 of the array of pixel mirrors 110. Reflective elements 120c are along the side 113 of the array of pixels 110, and reflective elements 120d are along the side 114.

The light shield 130 surrounds the array of pixels 110 and reflective elements 120. In one example, the light shield 130 may include metal whose top surface is coated with an antireflective material.

The pixels 110 and reflective element 120 may include multiple metal layers separated by other layers including, for example, dielectric materials. The mirror of pixels 110 and reflective element 120 is on top of a hinge. Most of the exposed metal reflective surfaces of the reflective elements (other than the mirror itself) may be coated with an antireflective material to reduce the likelihood that incoming light 140 will reflect off any surface other than the mirrors themselves. It may be difficult to coat all of the exposed metal surfaces of the pixels 110 and reflective elements 120 with the antireflective material. For example, the antireflective material may not coat the vertical surfaces of the pixels 110 and reflective elements 120 orthogonal to the plane of the DMD 100. Most of the surfaces of the pixels 110 not coated with the antireflective material are blocked by other mirrors and thus not in the “line of sight” of incoming light 140.

However, a light artifact may be caused by exposed vertical metal surfaces 125 (not coated with an antireflective material) of the frontside row of reflective elements 120a, which are not otherwise blocked from incoming light 140 by other mirrors. Incoming light 140 may undesirably reflect and/or scatter off surfaces 125 and into the optical element. Further, a portion 130a of the light shield 130 along the backside row of reflective elements 120b also may have an exposed vertical surface 160 that can reflect incoming light 140 depending on the positioning of the mirrors of the reflective elements 120b. Incoming light 140 may undesirably reflect and/or scatter off surfaces 160 and into the optical element. The examples described herein address this problem.

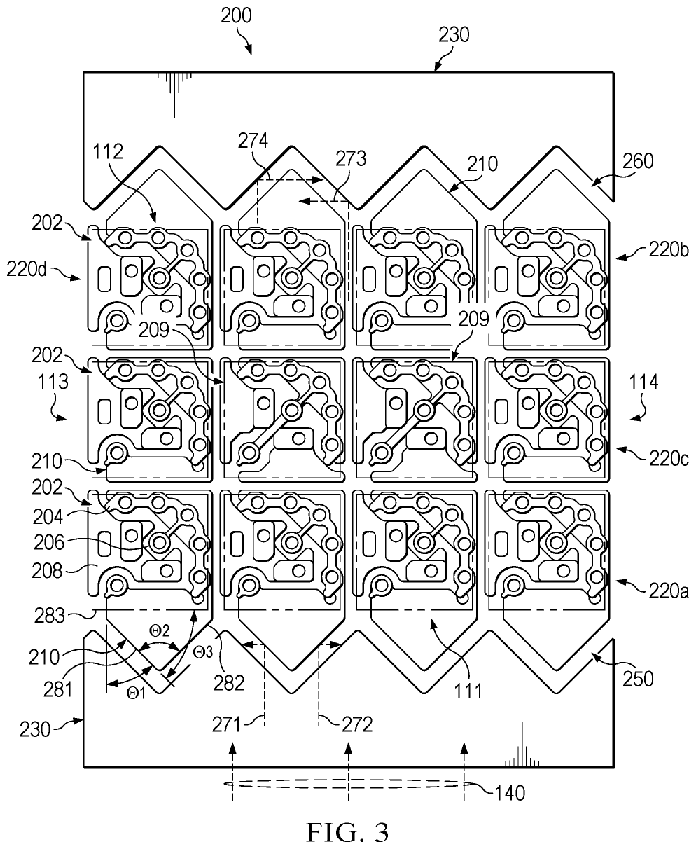

FIG. 3 is an example of a DMD 200 which includes a frontside row of reflective elements 220a along the front side 111 of DMD 200, a backside row of reflective elements 220b along opposing back side 112 of DMD 200, and an array of pixel mirrors 209. Side columns of reflective elements 120c and 120d may be provided at the sides 113 and 114 of DMD 200, as shown as reflective elements 220c and 220d, respectively. Although a single row of reflective elements 220a are shown along the front side 111 and a single row of reflective elements 220b are shown along the back side 112, in other examples, multiple rows (e.g., 20 rows) of reflective elements 220a and 220b may be provided along sides 111 and 112, respectively. Similarly, reflective elements 120c and 120d may include multiple columns of reflective elements 220c. Further, two pixel mirrors 209 are shown in FIG. 3 within the border set of reflective elements 220a, 220b, and 220c, but in general, more than two pixel mirrors 209 may be included, such as hundreds of pixel mirrors, thousands of pixel mirrors, etc.

The pixel mirrors 209 and reflective elements 220a, 220b, and 220c include mirrors 202 which are shown in FIG. 3 in transparent outline. A light shield 230 is around the reflective elements 220a, 220b, and 220c and the pixel mirrors 209. The reflective elements 220a along the frontside 111 of DMD 200 include metal layers 210. In the example of FIG. 3, the portion of the light shield 230 adjacent to the reflective elements 220a is separated from the metal layers 210 by a zig-zag shaped gap 250. Similarly, the portion of the light shield 230 adjacent the reflective elements 220b along the backside 112 of DMD 200 is separated from the metal layers 210 of reflective element 220b by a zig-zag shaped gap 260. The zig-zag shape of gap 250 causes any vertically exposed surface of metal layers 210 (not coated with an antireflective material) of reflective elements 220a to reflect and/or scatter incoming light 140 towards the sides 113 and 114 of DMD 200 as indicated by arrows 271 and 272, rather than through the optical element, thereby reducing and possibly eliminating light artifacts. Similarly, the zig-zag shape of gap 260 also causes any vertically exposed surface of metal layers 210 of reflective elements 220b to reflect and/or scatter incoming light 140 towards the sides 113 and 114 of DMD 200 as indicated by arrows 273 and 274, rather than through the optical element, thereby also reducing the likelihood of light artifacts.

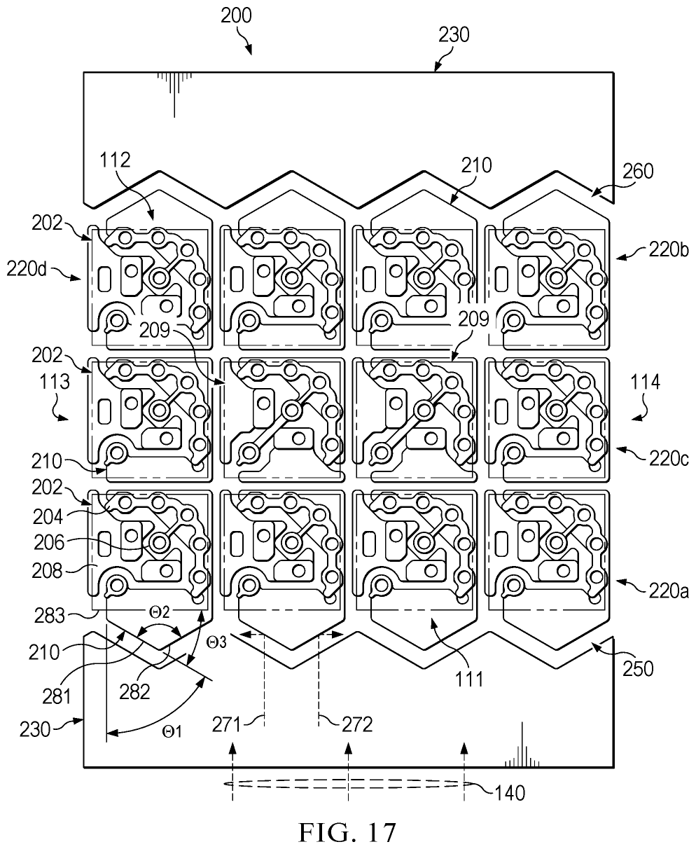

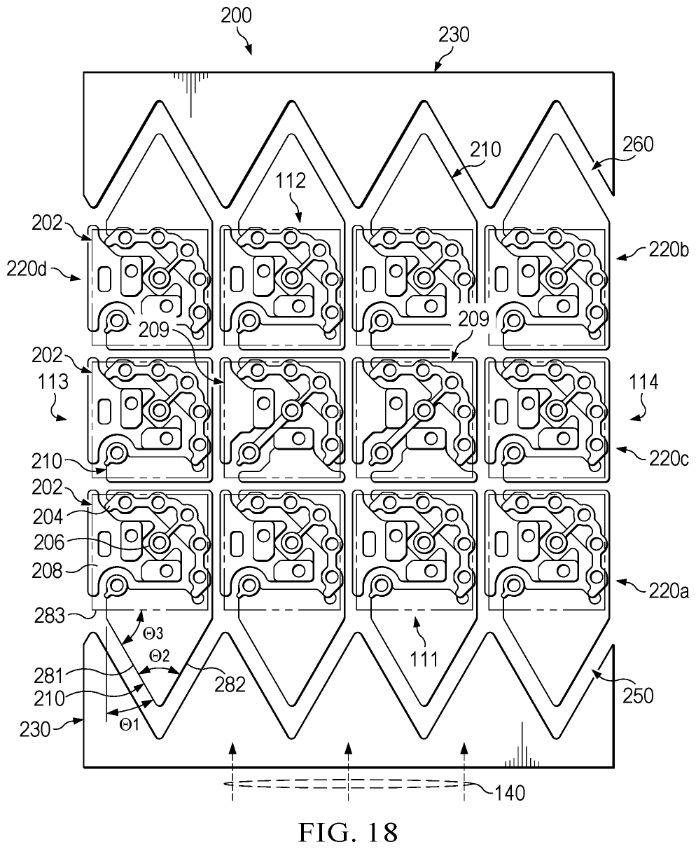

For at least some of the reflective elements 220a, the metal layer 210 includes adjacent surfaces 281 and 282. The angle between surface 281 and the direction of the incoming light 140 and between surface 282 and incoming light 140 is Θ1. The angle between the surfaces 281 and 282 is Θ2, which is 2*Θ1. The angle between surface 281 and the front edge 283 of mirror 202 is Θ3, which is complementary to angle Θ1. In the example of FIG. 3, Θ1 and Θ3 are 45° and Θ2 is 90°. FIGS. 17 and 18 (described below) illustrate DMDs in which Θ1, Θ2, and Θ3 are at different angles than that of FIG. 3. In general, Θ1 and Θ3 are between 30° and 60° (with Θ3 being complementary to Θ1), and Θ2 is between 60° and 120°.

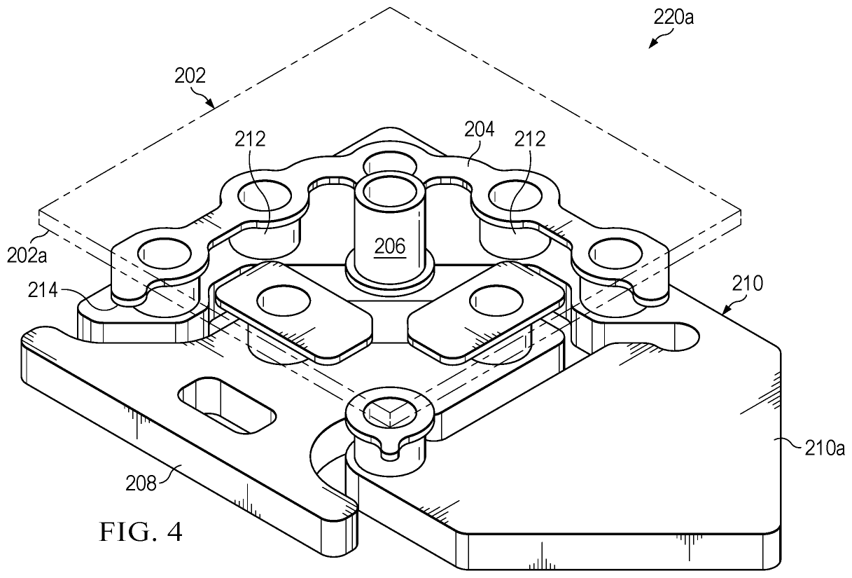

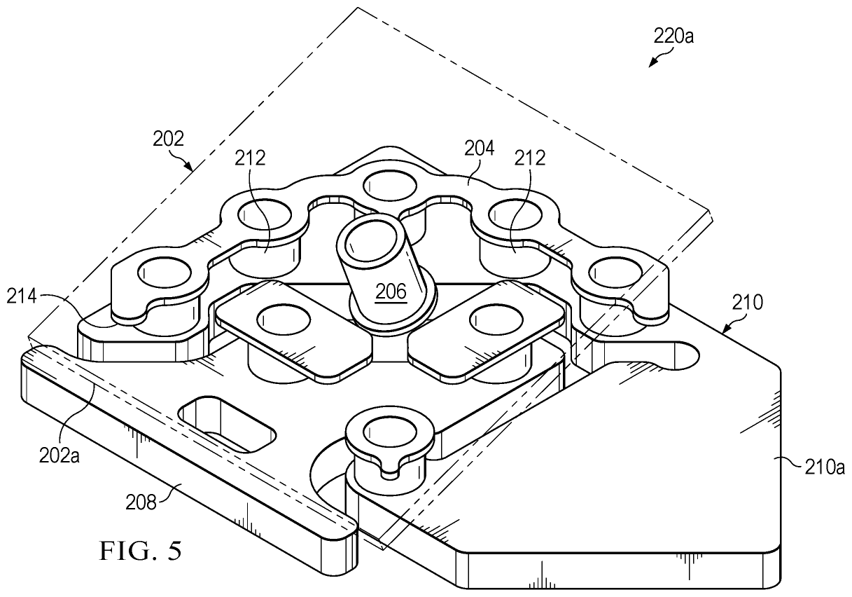

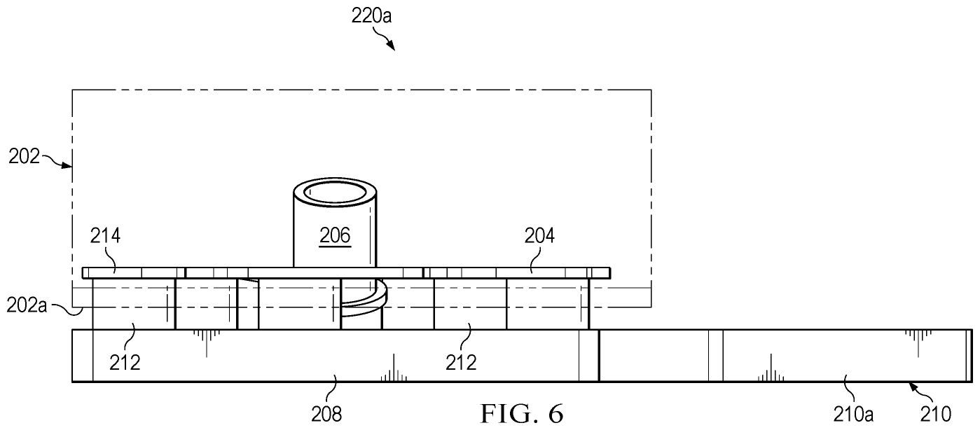

FIGS. 4, 5, and 6 are views of a reflective element 220a with mirror 202 in a rest position (FIG. 4) and in a tilted position (FIG. 5) and a side view (FIG. 6). Some of the structures of the reflective element 220a are also identified in FIG. 3. The reflective element 220a includes mirror 202 (shown transparently), which may be a reflective metal (e.g., aluminum). The structures below the mirror 202 include a hinge 204, a mirror via 206, an electrode 208, and the metal layer 210. Metal layer 210 may function as a reset bias line to land the mirrors 202 when a bias voltage is applied, or to release the mirrors when a low voltage is applied. For pixel mirrors 209, a dynamic reset waveform can be applied to cause the mirrors to transition to a new land state according to the address data loaded into a static random access memory (SRAM) cell (not shown). The mirror via 206 is between the hinge 204 and the bottom surface of the mirror 202. In other words, the mirror 202 is supported above the hinge 204 by the mirror via 206. Multiple hinge vias 212 (five hinge vias 212 in this example) support the hinge 204 above the metal layer 210. A voltage potential can be applied to the mirror 202 through the hinge 204 and the mirror via 206. The electrode 208 and the metal layer 210 may be parts of the same metal layer (e.g., aluminum) but are electrically isolated from each other (e.g., by a dielectric material such as silicon dioxide). A voltage difference applied between electrode 208 and mirror 202 can cause the edge 202a of the mirror 202 adjacent electrode 208 to tilt down towards the electrode 208, as illustrated in FIG. 5. The hinge 204 includes a spring tip 214, which functions as a mechanical stop. As the edge 202a of the mirror 202 tilts towards electrode 208, the bottom surface of the mirror contacts spring tip 214 to prevent the mirror from tilting even further and damaging the mirror 202 and/or hinge 204. The downward tilt of the left edge 202a of the mirror 202 represents the off state of the reflective element 220a. The mirror 202 can tilt in only one direction for the reflective elements 220a-, 220b, 220c, and 220d.

The metal layer 210 includes an angled extension 210a, which is generally triangular as shown. The gap 250 described above is between the angled extension 210a and the light shield 230. FIG. 6 is a side view of the reflective element 120a from the side having electrode 208 and with the mirror 202 angled down toward electrode 208. The angled extension 210a extends away from mirror 202. The reflective elements 220b have a similar structure to reflective elements 220a but the angled extension 210a is formed on the opposite side of the reflective element as shown in FIG. 3. In either case, the angled extensions 210a are part of the same metal layer 210.

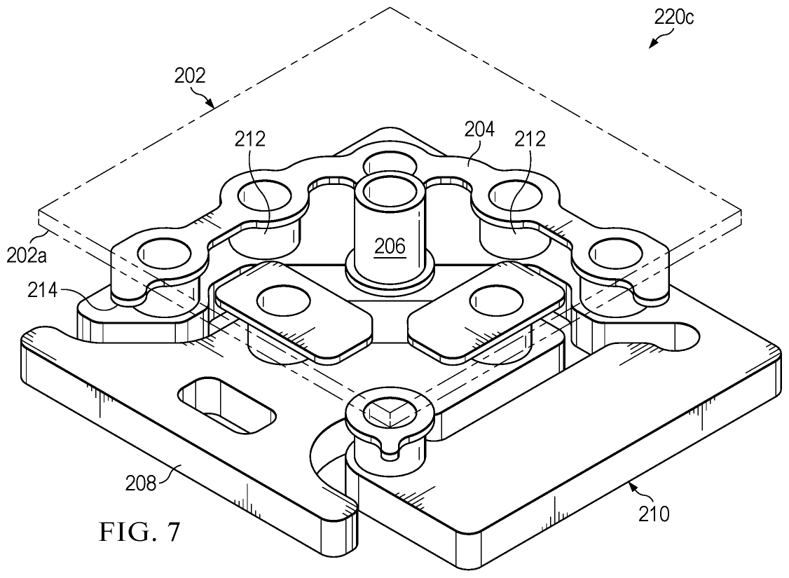

FIG. 7 is a view of reflective element 220c, which may be included along the sides 113 and 114 of DMD 200 in FIG. 3, and which may be used to implement reflective elements 120c and 120d in FIG. 2. The reflective elements 220c are similar to that of reflective elements 220a and 220b but may not have the angled extensions 210a of the metal layer 210. Because reflective elements 220c are formed at the sides 113 and 114 of the DMD 200, any exposed vertical surfaces are blocked from incoming light 140 by other reflective elements and thus they may not have any vertical surfaces that could reflect incoming light 140. Accordingly, the angled extensions 210a are not needed for the side reflective elements 220c.

FIG. 8 is a view of a pixel mirror 209 (which may be used to implement pixels 110 in FIG. 2), which is similar, but not identical, to the structure of the reflective element 220c. A pixel mirror 209 may have a second electrode 702, in addition to electrode 208, described above. The second electrode 702 is electrically isolated (e.g., by a dielectric material) from the metal layer 210. Application of a potential difference between either electrode 208, 702 and mirror 202 causes the corresponding mirror edge to tilt downward towards the respective electrode. The hinge 204 includes a second spring tip 704, opposite spring tip 214, to function as a mechanical stop for the mirror 202 as it tilts towards electrode 702. Because a pixel mirror 209 has two electrodes 208 and 702, the mirror 202 for a pixel mirror 209 can tilt in two directions. In the example of FIG. 8, the mirror 202 can tilt along two orthogonal axes—towards electrode 208 along a first axis 711 and towards electrode 702 along a second axis 712. Accordingly, the mirrors 202 of pixel mirrors 209 can tilt in at least two orientations.

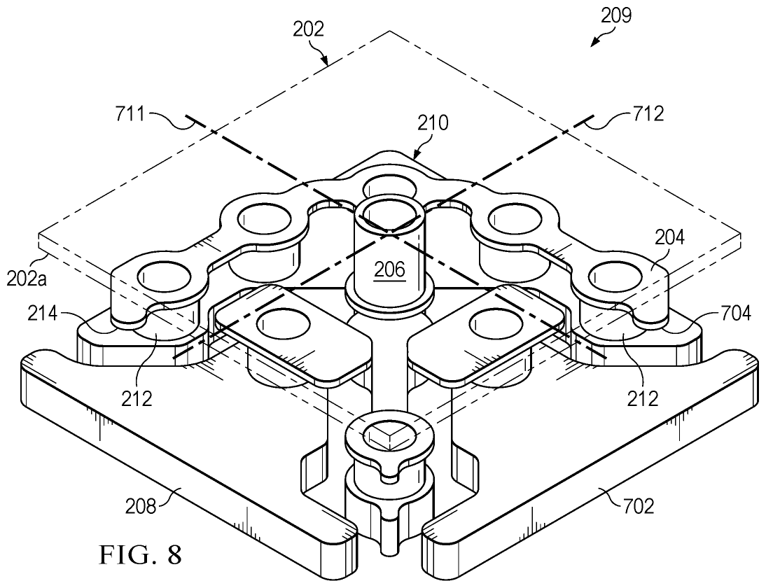

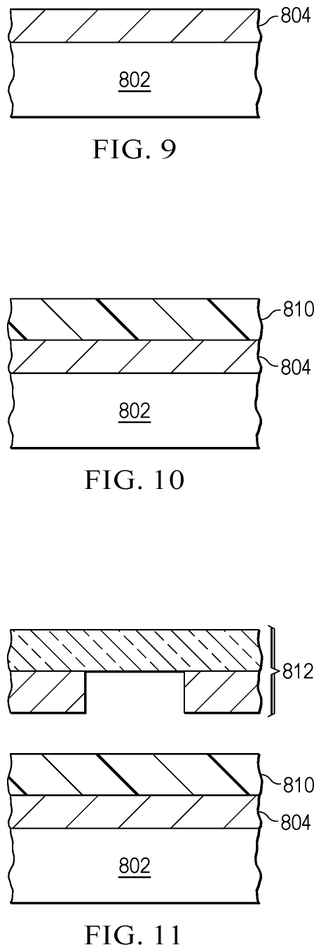

FIGS. 9-11 and 13-16 are cross-sectional views of DMD 200 illustrating a sequence of process steps for fabricating the DMD. Although a method for forming a single DMD 200 is shown in these figures, in some examples, the illustrated process steps are performed on a wafer to fabricate multiple DMDs 200 on a single wafer.

In FIG. 9, the process includes forming a metal layer 804 on a substrate. The metal layer 804 may be aluminum or gold or any other suitable metal. The substrate 802 may include other underlying metal and dielectric layers. The metal layer 804 may be formed by, for example, a sputter deposition process.

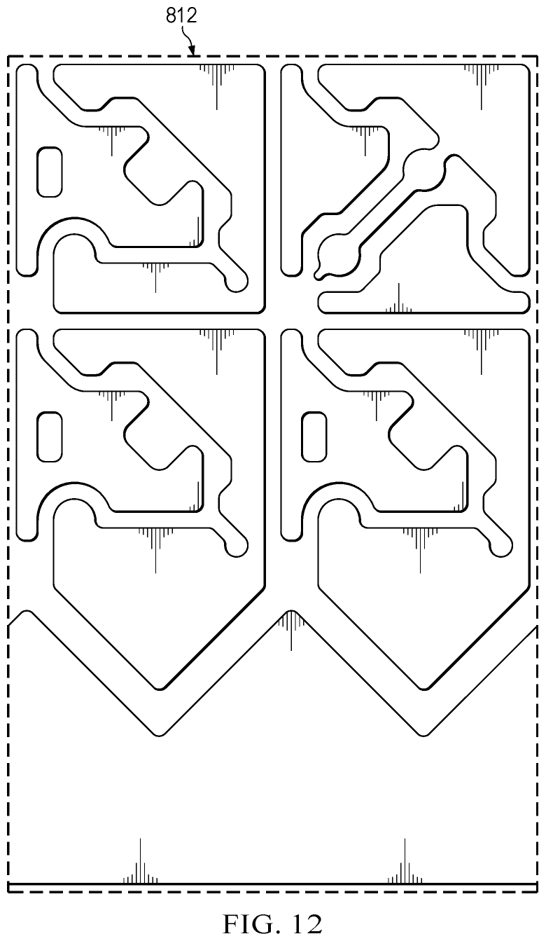

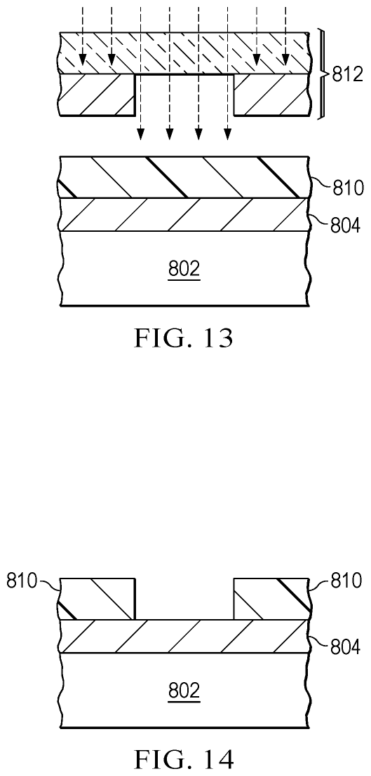

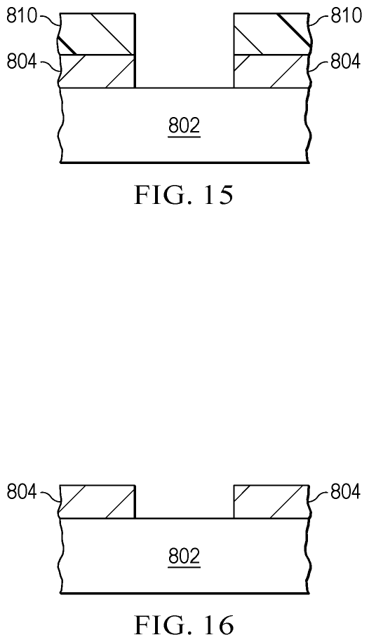

In FIG. 10, photoresist 810 is formed on the metal layer 804. In FIG. 11, a mask 812 is placed over the photoresist. A top-down view of a portion of an example mask 812 is shown in FIG. 12. The portion of the pattern of mask 812 corresponds to the metal below the mirrors 202 of, for example, two reflective elements 220a (e.g., electrodes 208 and 702, and metal layer 210 including angled extension 210a for reflective elements 220a) and two reflective elements 220c (which do not have angled extensions). The complete mask 812 will include a pattern for all of the reflective elements (without and without angled extensions) and pixel mirrors 209 for DMD 200. FIG. 13 illustrates application of ultraviolet (UV) light through the UV-transparent portions of mask 812 to expose photoresist 810 corresponding to the pattern of the mask. FIG. 14 illustrates a portion of photoresist 810 as having been removed. Those portions of metal layer 804 exposed through the photoresist 810 may be etched (e.g., reactive-ion etching) as shown in FIG. 15. Photoresist 810 is then removed as shown in FIG. 16. Additional process steps may be performed to form, for example, the mirror vias 206, hinge vias 212, hinges 204, and mirrors 202.

The DMDs of FIGS. 17 and 18 are similar to the DMD 200 of FIG. 3, but with different values of angles Θ1, Θ2, and Θ3. In FIG. 17, Θ1 is 60°, Θ2 is 120°, and Θ3 is 30°. In FIG. 18, Θ1 is 30°, Θ2 is 60°, and Θ3 is 60°. The geometry of mask 812 may be configured for the particular angles desired. Other examples may implement yet other angles as well for Θ1, Θ2, and Θ3.

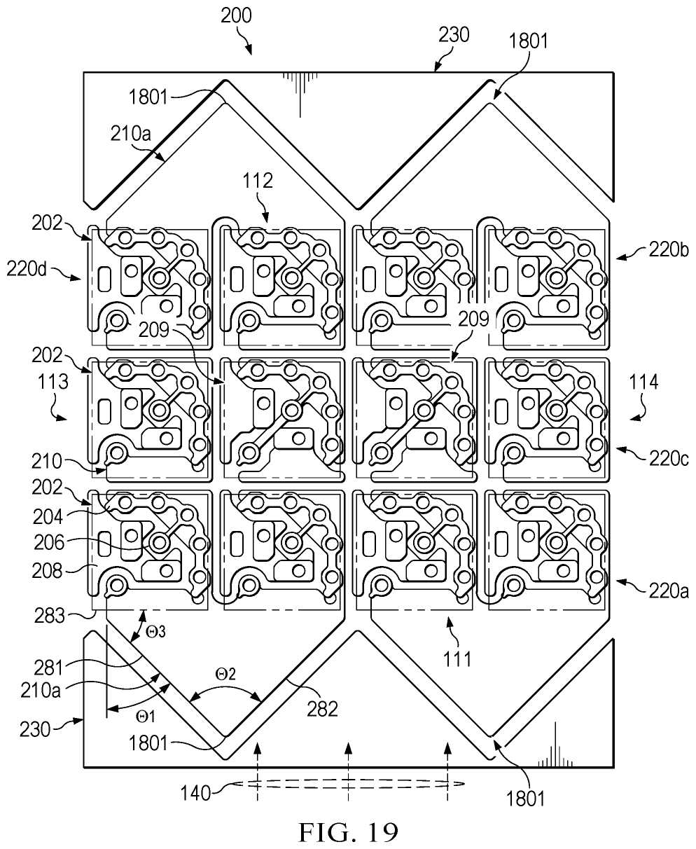

FIG. 19 is a top-down view of a DMD 200 in which each angled extension 210a spans multiple reflective elements 220a and 220b. In this example, each angled extension 210a spans two reflective elements 220a and 220b. The light shield 230 is patterned to match the zig-zag shape of the angled extensions 210a. The reflective elements 220b and the corresponding portion of light shield 230 is similarly patterned as shown. The tips 1801 between adjacent surfaces 281 and 282 of the angled extensions 210a may present reflective vertical surfaces that are approximately orthogonal to the direction of incoming light 140 and thus may cause a small amount of light artifact. By forming the DMD 200 such that each angled extension 210a spans multiple reflective elements 220 and 220b results in the DMD 200 of FIG. 19 having fewer reflective tips 1801 than for DMD 200 in FIG. 3, and thus DMD 200 of FIG. 19 may result in less light artifacts than DMD 200 of FIG. 3.

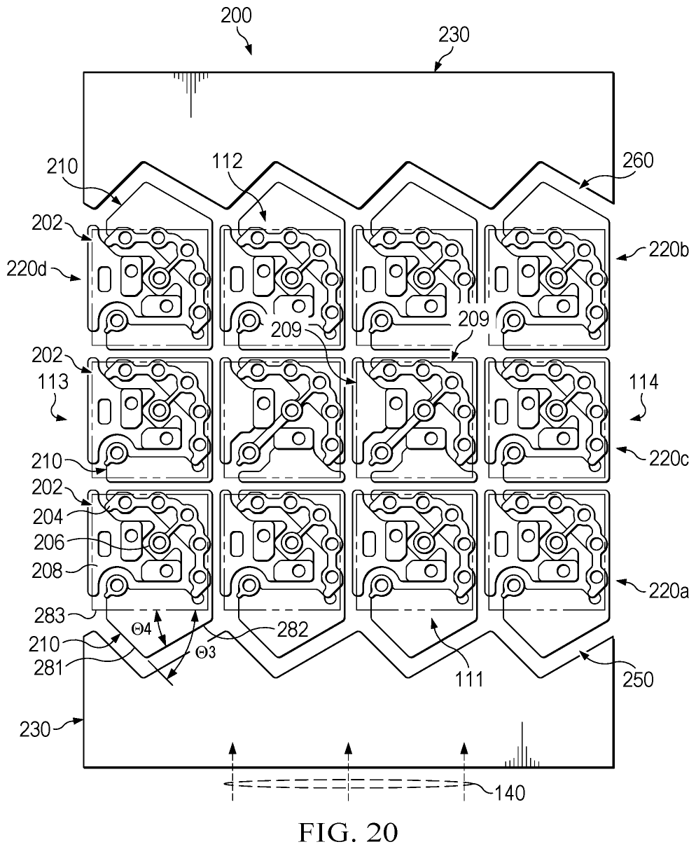

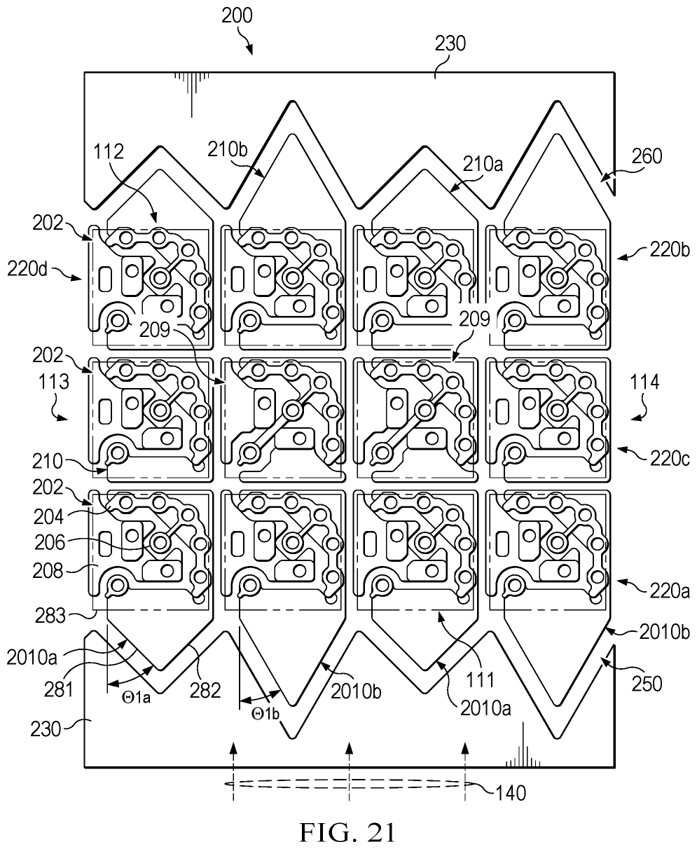

FIGS. 20 and 21 are top-down views of DMDs 200 illustrating alternative zig-zag shapes of gaps 250 and 260. In FIG. 20, angle Θ4 is the angle between surface 281 of angled extension 210a and the front edge 283 of mirror 202. In this example, angle Θ3 is different than angle Θ4. For example, angle Θ3 may be 45° and angle Θ4 may be 30°. The shape of each angled extension 210a may be the same for all of the reflective elements 220a and 220b. In FIG. 21, the shape of every other angled extension (e.g., angled extensions 2010a) may have the same shape and angles, and alternating angled extensions (e.g., angled extensions 2010b) may have the same shape albeit different angles than angled extensions 2010a (i.e., Θ1a for angled extensions 2010a is different than corresponding Θ1b for angled extensions 2010b).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A device comprising:
a spatial light modulator (SLM) having first and second opposing sides and third and fourth opposing sides, the SLM including an array of pixels, the SLM also including reflective elements along the first side, at least some of the reflective elements having a metal layer; and
a light shield having a first portion adjacent the reflective elements, a gap between the metal layers and the light shield having a zig-zag shape.

2. The device of claim 1, wherein the reflective elements are first reflective elements and the metal layer is a first metal layer, and the device further comprises second reflective elements along the second side, at least some of the second reflective elements having a second metal layer, and wherein the light shield has a second portion adjacent the second reflective elements, a gap between the second metal layers and the second portion of the light shield having the zig-zag shape.

3. The device of claim 1, wherein the light shield comprises a metal layer having a top surface coated with an antireflective material.

4. The device of claim 1, wherein the pixels include at least one of micromirror structures, liquid crystal display elements, or liquid crystal on silicon elements.

5. The device of claim 1, wherein:
the array of pixel elements includes micromirror structures configured to tilt in at least two directions; and
the reflective elements include micromirror structures configured to tilt in only one direction.

6. The device of claim 1, wherein the device is configured to receive light along a direction, and the zig-zag shape includes a first set of surfaces at an angle with respect to the direction, the angle in a range from 30 degrees to 60 degrees.

7. A device comprising:
a spatial light modulator (SLM) having first and second opposing sides and third and fourth opposing sides, the SLM including an array of pixels, the SLM also including reflective elements along the first side, at least some of the reflective elements having a metal layer corresponding to a reflective element of the reflective elements, the metal layer having a first edge and a second edge adjacent the first edge, an angle between the first edge and an edge of the reflective element being between 30 degrees and 60 degrees; and
a light shield having a first portion adjacent the first side, the first portion comprising a first surface facing the first edge of the metal layer and a second surface facing the second edge of the metal layer, an angle between the first and second surfaces between 30 degrees and 60 degrees.

8. The device of claim 7, further including an angle between the second edge and the edge of the reflective elements being between 30 degrees and 60 degrees.

9. The device of claim 7, wherein the reflective elements are first reflective elements and the metal layer is a first metal layer, and wherein the SLM includes second reflective elements along the second side, at least some of the second reflective elements having a second metal layer, a metal layer of the second metal layers corresponding to a reflective element of the second reflective elements, the metal layer of the second metal layers having a third edge and a fourth edge adjacent the third edge, an angle between the third edge and an edge of the reflective element of the second reflective elements being between 30 degrees and 60 degrees.

10. The device of claim 7, wherein the light shield comprises a second portion adjacent the second side, the second portion comprising a third surface and a fourth surface adjacent the third surface, an angle between the third and fourth surfaces being between 30 degrees and 60 degrees.

11. The device of claim 7, wherein the pixels include at least one of micromirror structures, liquid crystal display elements, or liquid crystal on silicon elements.

12. The device of claim 7, wherein:
the array of pixel elements includes micromirror structures configured to tilt in at least two orientations; and
the reflective elements include micromirror structures configured to tilt in only one orientation.

13. The device of claim 7, wherein the metal layer corresponding to the reflective elements of the reflective elements corresponds to at least two reflective elements.

14. A light projection system comprising:
a spatial light modulator (SLM) having first and second opposing sides and third and fourth opposing sides, the SLM including an array of pixels, the SLM also including reflective elements along the first side, at least some of the reflective elements having a metal layer;
a light shield having a first portion adjacent the reflective elements, a gap between the metal layers and the first portion having a zig-zag shape;
a light source configured to emit light towards the array of pixel elements, the array of pixels configured to modulate the light to produce modulated light; and
optics configured to project the modulated light.

15. The light projection system of claim 14, wherein the gap is a first gap, and wherein the light shield has a second portion adjacent the second side, a second gap between the second portion and the second side having a zig-zag shape.

16. The light projection system of claim 15, wherein the reflective elements are first reflective elements, and the SLM further comprises second reflective elements along the second side, the second gap is between at least some of the second reflective elements and the second portion.

17. The light projection system of claim 14, wherein the light shield comprises a metal layer having a top surface coated with an antireflective material.

18. The light projection system of claim 14, wherein the pixel elements include at least one of micromirror structures, liquid crystal display elements, or liquid crystal on silicon elements.

19. The light projection system of claim 14, wherein:
the array of pixel elements includes micromirror structures configured to tilt in at least two orientations; and
the reflective elements include micromirror structures configured to tilt in only one orientation.

20. The light projection system of claim 14, wherein the light source is configured to direct light along a direction, and the zig-zag shape includes a first set of surfaces at an angle with respect to the direction, the angle being in a range from 30 degrees to 60 degrees.
